(19) United States
(12) Patent Application Publication
(10) Pub. No.: US 2013/0158221 A1
(43) Pub. Date: Jun. 20, 2013

(54) OPTICAL PRESSURE-SENSITIVE ADHESIVE SHEET

(71) Applicant: NITTO DENKO CORPORATION, Osaka (JP)

(72) Inventors: Tomohide BANBA, Osaka (JP); Hiroaki KISHIOKA, Osaka (JP); Takahiro NONAKA, Osaka (JP); Masatomo NATSUI, Osaka (JP); Hiroaki FUMOTO, Osaka (JP); Shou TAKARADA, Osaka (JP); Takashi SUZUKI, Osaka (JP)

(73) Assignee: NITTO DENKO CORPORATION, Osaka (JP)

(21) Appl. No.: 13/717,986

(22) Filed: Dec. 18, 2012

(30) Foreign Application Priority Data
Dec. 20, 2011 (JP) 2011-278535

(51) Int. Cl. C09J 139/06; C09J 133/12; C09J 133/14

(52) U.S. Cl. CPC C09J 139/06; C09J 133/14; C09J 133/12
USPC 526/263; 526/320; 526/318.42; 526/328.5

(57) ABSTRACT

The present invention provides an optical pressure-sensitive adhesive sheet which can control the change in capacitance, which cause malfunction, when the optical pressure-sensitive adhesive sheet is applied to an optical member. The present invention provides an optical pressure-sensitive adhesive sheet including a pressure-sensitive adhesive layer, wherein a relative dielectric constant at a frequency of 1 MHz is 2 to 8, and a dielectric tangent at a frequency of 1 MHz is more than 0 and 0.2 or less.

### BACKGROUND OF THE INVENTION

1. Technical Field

The present invention relates to an optical pressure-sensitive adhesive sheet.

2. Background Art

Recently, display devices such as liquid crystal displays (LCDs) or input devices, such as a touch panel, which is used by combining the display device has been widely used in various fields. In manufacturing the display devices or the input devices, a pressure-sensitive adhesive sheet is used for laminating optical members (see, for example, Patent Document 1).

A touch panel has been considered as a trend of image display methods, and in particular, electric capacity type touch panels have become widely used. In such an electric capacity type touch panel, a pressure-sensitive adhesive layer (layer composed of a pressure-sensitive adhesive) is used as an insulating layer as well as is used for laminating a transparent member. The electric capacity type touch panel has a structure in which, when the touch panel is touched by a finger or the like, an output signal of the corresponding position changes, and sensing is performed when the amount of the signal change exceeds a predetermined threshold value. In the electric capacity type touch panel, if the capacitance value is not stable at a given value, this may cause malfunction.
Patent Document 1: JP-A-2002-363523

### SUMMARY OF THE INVENTION

However, in an electric capacity type touch panel using a pressure-sensitive adhesive layer of the related art, there are cases where malfunction may be caused by the pressure-sensitive adhesive layer. In particular, there are cases where malfunction occurs when a signal is changed greatly due to noise output from the outside, for example, from a display device.

The present invention has been made in an effort to provide an optical pressure-sensitive adhesive sheet in which functionality or characteristics of optical members are not impaired when the optical pressure-sensitive adhesive sheet is applied to the optical members. Particularly, the present invention provides an optical pressure-sensitive adhesive sheet that can prevent malfunction when the optical pressure-sensitive adhesive sheet is used for laminating a transparent member in the electric capacity type touch panel to configure a touch panel.

The present inventors have intensively studied in order to solve the problems. As a result, the inventors have found that, when an optical pressure-sensitive adhesive sheet in which a relative dielectric constant at a frequency of 1 MHz is set within a specific range, and a dielectric tangent at a frequency of 1 MHz is set within a specific range is used, malfunction of an optical member is not caused, and sensitivity required for an optical member does not deteriorate. Particularly, the present inventors have found that, when the optical pressure-sensitive adhesive sheet is used for an electric capacity type touch panel, malfunction of the electric capacity type touch panel is not caused and sensitivity thereof does not deteriorate.

That is, the present invention provides an optical pressure-sensitive adhesive sheet including a pressure-sensitive adhesive layer, wherein a relative dielectric constant at a frequency of 1 MHz is 2 to 8, and a dielectric tangent at a frequency of 1 MHz is more than 0 and 0.2 or less.

The present invention also provides the above-described optical pressure-sensitive adhesive sheet, wherein the relative dielectric constant at a frequency of 1.0×10⁶ Hz is 60% or more of a relative dielectric constant at a frequency of 1.0×10⁴ Hz.

The present invention also provides the above-described optical pressure-sensitive adhesive sheet, wherein an absolute value of a difference between the dielectric tangent at a frequency of 1.0×10⁶ Hz and a dielectric tangent at a frequency of 1.0×10⁴ Hz is 0.15 or less.

The present invention also provides the above-described optical pressure-sensitive adhesive sheet, which has a thickness accuracy of 10% or less.

The present invention also provides the above-described optical pressure-sensitive adhesive sheet, wherein the pressure-sensitive adhesive layer is an acrylic pressure-sensitive adhesive layer.

The present invention also provides the above-described optical pressure-sensitive adhesive sheet, wherein the acrylic pressure-sensitive adhesive layer includes, as a base polymer, an acrylic polymer formed from a component including, as an essential monomer component, alkyl (meth)acrylate having a straight-chain or branched alkyl group having 1 to 14 carbon atoms and/or alkoxyalkyl (meth)acrylate.

The present invention also provides the above-described optical pressure-sensitive adhesive sheet, wherein the acrylic pressure-sensitive adhesive layer is formed by an ultraviolet-ray polymerization method through ultraviolet irradiation to a pressure-sensitive adhesive composition.

The present invention also provides the above-described optical pressure-sensitive adhesive sheet, which is used for laminating members contained in a touch panel.

The present invention also provides the above-described optical pressure-sensitive adhesive sheet, wherein the touch panel is an electric capacity type touch panel.

The present invention also provides a liquid crystal display device or input device including the above-described optical pressure-sensitive adhesive sheet.

The optical pressure-sensitive adhesive sheet according to the present invention has the above configuration. Therefore, when the optical pressure-sensitive adhesive sheet is applied to optical members, functionality or characteristics of the optical members are not impaired. Particularly, the optical pressure-sensitive adhesive sheet can prevent malfunction when the optical pressure-sensitive adhesive sheet is used for laminating a transparent member in the electric capacity type touch panel to configure a touch panel.

### BRIEF DESCRIPTION OF THE DRAWINGS

FIG. 1 is a schematic view illustrating an embodiment of an electric capacity type touch panel formed by laminating members using an optical pressure-sensitive adhesive sheet according to the present invention.

### DETAILED DESCRIPTION OF THE INVENTION

In an optical pressure-sensitive adhesive sheet according to the present invention, a relative dielectric constant at a frequency of 1 MHz is 2 to 8, and a dielectric tangent at a frequency of 1 MHz is more than 0 and 0.2 or less. The optical pressure-sensitive adhesive sheet according to the present invention is used as an insulating body as well as is used for laminating optical members.

The optical pressure-sensitive adhesive sheet according to the present invention has at least a pressure-sensitive adhesive layer and includes any forms such as a tape and a sheet. The pressure-sensitive adhesive sheet according to the present invention may be a substrateless type pressure-sensitive adhesive sheet that does not have substrate (substrate layer), or a pressure-sensitive adhesive sheet with substrate (substrate layer). The optical pressure-sensitive adhesive sheet may be a single-sided pressure-sensitive adhesive sheet having a pressure-sensitive adhesive property on only one side thereof or a double-sided pressure-sensitive adhesive sheet having an pressure-sensitive adhesive property on both sides thereof. The pressure-sensitive adhesive layer providing a pressure-sensitive adhesive surface may be a single layer structure or a laminate structure. The “substrate (substrate layer)” does not include a release liner (separator) to be released when used.

In the optical pressure-sensitive adhesive sheet according to the present invention, the relative dielectric constant at a frequency of 1 MHz is 2 to 8 and preferably 2.5 to 6.5, from the viewpoint of not impeding functionality or characteristics of optical members when the optical pressure-sensitive adhesive sheet is applied to the optical members and the viewpoint of sensitivity and stability particularly when the optical pressure-sensitive adhesive sheet is applied to an electric capacity type touch panel. For example, in the case where the optical pressure-sensitive adhesive sheet according to the present invention is applied to the electric capacity type touch panel, when the relative dielectric constant at a frequency of 1 MHz is less than 2, the capacitance value required for sensing the touch panel is decreased, thereby being easily affected by a noise signal, and the ratio of a sensing signal to noise is decreased, thereby easily causing malfunction, which is not desirable. Meanwhile, when the relative dielectric constant at a frequency of 1 MHz is more than 8, the capacitance value becomes too large, thereby easily causing a time delay in signal and decreasing the sensitivity, which is not desirable.

In the optical pressure-sensitive adhesive sheet according to the present invention, the dielectric tangent at a frequency of 1 MHz is 0.2 or less (for example, more than 0 and 0.2 or less) and preferably 0.15 or less (for example, more than 0 and 0.15 or less), from the viewpoint of efficiently utilizing electrical energy required for driving a touch panel particularly when the optical pressure-sensitive adhesive sheet is applied to the electric capacity type touch panel. When the dielectric tangent at a frequency of 1 MHz is more than 0.2, a large amount of electrical energy is lost when the optical pressure-sensitive adhesive sheet is applied to an electric capacity type touch panel, and a large amount of power required for driving a panel is consumed, which is not desirable.

In addition, in the optical pressure-sensitive adhesive sheet according to the present invention, a relative dielectric constant at a frequency of 1.0×10⁶ Hz is preferably 60% or more of a relative dielectric constant at a frequency of 1.0×10⁴ Hz and more preferably 70% or more of a relative dielectric constant at a frequency of 1.0×10⁴ Hz, from the viewpoint of operational stability of a touch panel particularly when the optical pressure-sensitive adhesive sheet is applied to the electric capacity type touch panel. When the relative dielectric constant at a frequency of 1.0×10⁶ Hz is less than 60% of the relative dielectric constant at a frequency of 1.0×10⁴ Hz, if the frequency of a signal in the touch panel is affected by noise and is greatly changed, the relative dielectric constant is greatly changed and the capacitance value is greatly changed. As a result, there are cases where sensing is unstable, thereby causing malfunction.

In addition, in the optical pressure-sensitive adhesive sheet according to the present invention, the absolute value of a difference between a dielectric tangent at a frequency of 1.0×10⁶ Hz and a dielectric tangent at a frequency of 1.0×10⁴ Hz is preferably 0.15 or less and more preferably 0.12 or less, from the viewpoint of operational stability of a touch panel particularly when the optical pressure-sensitive adhesive sheet is applied to the electric capacity type touch panel. When the absolute value of the difference between a dielectric tangent at a frequency of 1.0×10⁶ Hz and the dielectric tangent at a frequency of 1.0×10⁴ Hz is more than 0.15, there are cases where malfunction is caused due to a large change in frequency of a signal, for example, when the optical pressure-sensitive adhesive sheet is used for an electric capacity type touch panel.

In this specification, “the relative dielectric constant” represents a dielectric constant defined by JIS K 6911. The relative dielectric constant and the dielectric tangent are determined in accordance with JIS K 6911.

In the optical pressure-sensitive adhesive sheet according to the present invention, a thickness accuracy (thickness variation) is preferably 10% or less and more preferably 5% or less with respect to a desired thickness, from the viewpoint of operational stability of a touch panel particularly when the optical pressure-sensitive adhesive sheet is applied to the electric capacity type touch panel. When the thickness accuracy is more than 10%, for example, there is a concern that the capacitance of the optical pressure-sensitive adhesive sheet is changed. Such a change in capacitance changes an output signal when the optical pressure-sensitive adhesive sheet is applied to an electric capacity type touch panel, thereby causing malfunction.

The thickness accuracy is determined as follows. Five points are set in a range of 50 mm×75 mm in a longitudinal direction and the thickness of each measurement point is measured using a 1/1000 dial gauge. A numerical value obtained by dividing the difference between the maximum thickness and a desired thickness by the desired thickness is represented by percent (refer to the following expression (1)), and a numerical value obtained by dividing the difference between the minimum thickness and the desired thickness by the desired thickness is represented by percent (refer to the following expression (2)). The former absolute value is compared to the latter absolute value and a larger numerical value is set as the thickness accuracy (%).

(Maximum thickness−desired thickness)/(Desired thickness)×100 (1)

(Minimum thickness−desired thickness)/(Desired thickness)×100 (2)

The optical pressure-sensitive adhesive sheet according to the present invention is not particularly limited but preferably has a high transparency from the standpoint of visibility. For example, a total light transmittance in a visible light wavelength range (in accordance with JIS K 7361) is preferably 90% or more. In the pressure-sensitive adhesive layer according to the present invention, a haze (in accordance with JIS K 7136) is, for example, preferably 5.0% or less and more preferably 2.0% or less. The total light transmittance and haze can be measured using, for example, a haze meter (trade name “HM-150”, manufactured by Murakami Color Research Laboratory Co., Ltd.).

(Pressure-Sensitive Adhesive Layer)

A base polymer of a pressure-sensitive adhesive constituting a pressure-sensitive adhesive layer of the optical pressure-sensitive adhesive sheet is not particularly limited, and can be appropriately selected from base polymers of, for example, well-known pressure-sensitive adhesives (for example, acrylic pressure-sensitive adhesives, rubber-based pressure-sensitive adhesives, vinyl alkyl ether-based pressure-sensitive adhesives, silicone-based pressure-sensitive adhesives, polyester-based pressure-sensitive adhesives, polyamide-based pressure-sensitive adhesives, urethane-based pressure-sensitive adhesives, fluorine-based pressure-sensitive adhesives, epoxy-based pressure-sensitive adhesives, and polyether-based pressure-sensitive adhesives). The base polymers may be used either alone or in combination of two or more thereof.

The content of the base polymer in the pressure-sensitive adhesive layer of the optical pressure-sensitive adhesive sheet according to the present invention is preferably 60 wt % or more (for example, 60 wt % to 100 wt %), and more preferably 80 wt % to 100 wt % based on the total weight of the pressure-sensitive adhesive layer.

The base polymers of well-known acrylic pressure-sensitive adhesives or polyether-based pressure-sensitive adhesives are preferably used as the base polymer from the standpoint of transparency, processability, and durability, and the base polymers of acrylic pressure-sensitive adhesives are particularly preferably used.

The base polymers of polyether-based pressure-sensitive adhesives are not particularly limited, and examples thereof include a polyoxyalkylene-based polymer. The polyoxyalkylene-based polymer preferably has a repeating unit represented by the following general formula (I) in a main chain of the polymer.

—R¹—O— General formula (I)

(wherein R¹ is an alkylene group)

R¹ is preferably a straight-chain or branched alkylene group having 1 to 14 carbon atoms, and more preferably a straight-chain or branched alkylene group having 2 to 4 carbon atoms.

Specific examples of the repeating unit represented by the general formula (I) include —CH₂O—, —CH₂CH₂O—, —CH₂CH(CH₃)O—, —CH₂CH(CH₂H₅)O—, —CH₂C(CH₃)₂O— and —CH₂CH₂CH₂CH₂O—. The backbone of main chains of the polyoxyalkylene-based polymer may consist of only one type of repeating unit or two or more types of repeating units. Particularly, polymers having —CH₂CH(CH₃)O— as a main repeating unit are preferable from the standopint of availability and workability. Also, polymers having repeating units other than an oxyalkylene group may be included in the main chain thereof, wherein the sum of oxyalkylene units in the polymer is preferably 80 wt % or more, and more preferably 90 wt % or more.

A polyoxyalkylene-based polymer may be a straight-chain polymer, a branched polymer, or a mixture thereof, and the polyoxyalkylene-based polymer may include 50 wt % or more of the straight-chain polymer in order to obtain good pressure-sensitive adhesion.

An acrylic polymer as a base polymer of acrylic pressure-sensitive adhesives is formed from a component including an acrylic monomer as an essential monomer component. In the present invention, as such an acrylic monomer, alkyl (meth)acrylate having a straight-chain or branched alkyl group (hereinafter, sometimes simply referred to as “alkyl (meth)acrylate”) or alkoxyalkyl (meth)acrylate can be preferably used. In addition, the term “(meth)acryl” represents “acryl” and/or “methacryl” and the similarly for the others.

In the present invention, when alkyl (meth)acrylate having a straight-chain or branched alkyl group is used as the acrylic monomer, alkyl (meth)acrylate having a straight-chain or branched alkyl group may be used alone, or alkyl (meth)acrylate having a straight-chain or branched alkyl group and alkoxyalkyl (meth)acrylate may be used in combination. In the case where alkyl (meth)acrylate having a straight-chain or branched alkyl group and alkoxyalkyl (meth)acrylate are used in combination, a content ratio thereof is not particularly limited. The content of alkyl (meth)acrylate having a straight-chain or branched alkyl group may be more than, less than or the same as that of alkoxyalkyl (meth)acrylate.

The alkyl (meth)acrylate having a straight-chain or branched alkyl group is not particularly limited, and examples thereof include alkyl (meth)acrylate of which an alkyl group has 1 to 20 carbon atoms, such as methyl (meth)acrylate, ethyl (meth)acrylate, propyl (meth)acrylate, isopropyl (meth)acrylate, butyl (meth)acrylate, isobutyl (meth)acryalte, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. The alkyl (meth)acrylate may be used either alone or in combination of two or more thereof. Among them, an alkyl (meth)acrylate having 1 to 14 carbon atoms is preferable, and an alkyl (meth)acrylate having 1 to 10 carbon atoms is more preferable.

The alkoxyalkyl (meth)acrylate is not particularly limited, and examples thereof include 2-methoxyethyl (meth)acrylate, 2-ethoxyethyl (meth)acrylate, methoxytriethyleneglycol (meth)acrylate, 3-methoxypropyl (meth)acrylate, 3-ethoxypropyl (meth)acrylate, 4-methoxybutyl (meth)acrylate and 4-ethoxybutyl (meth)acrylate. Among them, an alkoxyalkyl acrylate is preferable and 2-methoxyethyl acrylate (2MEA) is more preferable. The alkoxyalkyl (meth)acrylate may be used either alone or in combination of two or more thereof.

A content of the acrylic polymer is preferably 70 wt % or more (for example, 70 wt % to 100 wt %), more preferably 80 wt % or more (for example, 80 wt % to 100 wt %), and still more preferably 90 wt % or more (for example, 90 wt % to 100 wt %) based on the total amount of the monomer component forming the acrylic polymer, from the standpoint of an adhesion property of the pressure-sensitive adhesive layer.

In addition, examples of the monomer components forming the acrylic polymer as the base polymer may include, as a copolymerizable monomer, polar group-containing monomers, multifunctional monomers, and other copolymerizable monomers, in addition to the acrylic monomers (alkyl (meth)acrylate having a straight-chain or branched alkyl group and alkoxyalkyl (meth)acrylate).

Examples of the polar group-containing monomers include: carboxyl group-containing monomers such as (meth)acrylic acid, itaconic acid, maleic acid, fumaric acid, crotonic acid, isocrotonic acid and anhydrides thereof (e.g., maleic anhydride); hydroxyl group-containing monomers such as vinyl alcohol, aryl alcohol, and hydroxyalkyl (meth)acrylate such as 2-hydroxyethyl (meth)acrylate, 3-hydroxypropyl (meth)acrylate, 4-hydroxybutyl (meth)acrylate and 6-hydroxyhexyl (meth)acrylate; amide group-containing monomers such as (meth)acrylamide, N,N-dimethyl (meth)acrylamide, N-methylol (meth)acrylamide, N-methoxymethyl (meth)acrylamide, N-butoxymethyl (meth)acrylamide and N-hydroxyethyl acrylamide; amino group-containing monomers such as aminoethyl (meth)acrylate, dimethylaminoethyl (meth)acrylate and t-butyl aminoethyl (meth)acrylate; glycydyl group-containing monomers such as glycidyl (meth)acrylate and methylglycidyl (meth)acrylate; cyano group-containing monomers such as acrylonitrile and methacrylonitrile; heterocyclic ring-containing vinyl monomers such as N-vinyl pyridine, N-vinyl piperidone, N-vinyl pyrimidine, N-vinyl piperazine, N-vinyl pyrrole, N-vinyl imidazole and N-vinyl oxazole in addition to N-vinyl-2-pyrrolidone and (meth)acryloyl morpholine; sulfonate group-containing monomers such as sodium vinyl sulfonate; phosphate group-containing monomers such as 2-hydroxyethyl acryloyl phosphate; imide group-containing monomers such as cyclohexyl maleimide and isopropyl maleimide; and isocyanate group-containing monomers such as 2-methacryloyloxyethyl isocyanate. The polar group-containing monomers may be used either alone or in combination of two or more thereof.

Among these, as the polar group-containing monomers, carboxyl group-containing monomers and anhydrides thereof, hydroxyl group-containing monomers, amino group-containing monomers, amide group-containing monomers, and heterocyclic ring-containing vinyl monomers are preferable, and acrylic acid (AA), methacrylic acid (MAA), 2-hydroxyethyl acrylate (2HEA), 6-hydroxyhexyl acrylate (HHA), 4-hydroxybutyl acrylate (4HBA), N-vinyl-2-pyrrolidone (NVP), and N-hydroxyethyl acrylamide (HEAA) are particularly preferable.

A content of the polar group-containing monomer is preferably 40 wt % or less (for example, 0.01 wt % to 40 wt %) and more preferably 1 wt % to 30 wt %, based on the total amount of the monomer component forming the acrylic polymer. When the content is more than 40 wt %, for example, cohesion force of the pressure-sensitive adhesive layer may be excessively increased and the stress relaxation properties may be lowered. When the content is less than 0.01 wt %, cohesion force of the pressure-sensitive adhesive layer may deteriorate and adhesion performance may be lowered.

As the multifunctional monomers, examples thereof include hexandiol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinyl benzene, epoxy acrylate, polyester acrylate and urethane acrylate. The multifunctional monomers may be used either alone or in combination of two or more thereof.

A content of the multifunctional monomer is preferably 5 wt % or less (for example, 0.001 wt % to 5 wt %) based on the total amount of the monomer component forming the acrylic polymer. When the content is more than 5 wt %, cohesion force of the pressure-sensitive adhesive layer may be excessively increased and the stress relaxation properties may be lowered.

As the copolymerizable monomers other than the polar group-containing monomers and multifunctional monomers as described above (other copolymerizable monomers), examples thereof include: (meth)acrylic acid ester other than the above-described alkyl (meth)acrylate, polar group-containing monomer and multifunctional monomer, such as (meth)acrylic acid ester having an alicyclic hydrocarbon group such as cyclopentyl (meth)acrylate, cyclohexyl (meth)acrylate and isobornyl (meth)acrylate, and (meth)acrylic acid ester having aromatic hydrocarbon groups such as phenyl (meth)acrylate; vinyl esters such as vinyl acetate and vinyl propionate; aromatic vinyl compounds such as styrene and vinyl toluene; olefins or dienes such as ethylene, butadiene, isoprene, and isobutylene; vinyl ethers such as vinyl alkyl ether; and vinyl chloride.

The acrylic polymer as the base polymer can be prepared by polymerizing the above monomer components by a known/general polymerization method. Examples of the polymerization method of the acrylic polymer include a solution polymerization method, an emulsion polymerization method, a bulk polymerization method and a polymerization method by active-energy-ray irradiation (an active-energy-ray polymerization method or a photopolymerization method). Among the above polymerization method, the solution polymerization method and active-energy-ray polymerization method are preferable from the standpoint of transparency, water resistance and costs, and particularly when a relatively thick pressure-sensitive adhesive layer is formed, an active-energy-ray polymerization method is preferable. Among the active-energy-ray polymerization methods, an ultraviolet-ray polymerization method through irradiation with ultraviolet rays is preferable.

As the active energy rays irradiated during the active-energy-ray polymerization (photopolymerization), examples thereof include ultraviolet rays, or ionizing radiations such as an α-ray, a β-ray, a γ-ray, a neutron ray, and an electron ray. Among them, the ultraviolet rays are preferable. Irradiation energy, irradiation time and irradiation method of active energy rays are not particularly limited as far as photopolymerization initiators can be activated to cause the reaction of monomer components.

As the solvent used in the solution polymerization, various general solvents are used. Examples of the solvents include organic solvents such as esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; ketones such as methyl ethyl ketone and methyl isobutyl ketone. Such solvents may be used either alone or in combination of two or more thereof.

Polymerization initiators such as a thermal polymerization initiator or a photopolymerization initiator (photo initiator) can be used depending on the type of polymerization reaction in the preparation of the acrylic polymer. The polymerization initiators may be used either alone or in combination of two or more thereof.

The photopolymerization initiator is not particularly limited, and examples thereof include a benzoin ether-based photopolymerization initiator, an acetophenon-based photopolymerization initiator, an α-ketol-based photopolymerization initiator, an aromatic sulfonylchloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator and a thioxanthone-based photopolymerization initiator.

Examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethane-1-one and anisole methyl ether. Examples of the acetophenone-based photopolymerization initiator include 2,2-diethoxyacetophenone, 2,2-dimethoxy-2-phenylacetophenone, 1-hydroxycyclohexylphenylketone, 4-phenoxydichloroacetophenone and 4-(t-butyl)dichloroacetophenone. Examples of the α-ketol based photopolymerization initiator include 2-methyl-2-hydroxypropiophenone and 1-[4-(2-hydroxyethyl)phenyl]-2-methylpropane-1-one. Examples of the aromatic sulfonyl chloride-based photopolymerization initiator include 2-naphthalenesulfonyl chloride. Examples of the photoactive oxime-based photopolymerization initiator include 1-phenyl-1,1-propandion-2-(o-ethoxycarbonyl)-oxime. Examples of the benzoin-based photopolymerization initiator include benzoin. Examples of the benzyl-based photopolymerization initiator include benzyl. Examples of the benzophenone-based photopolymerization initiator include benzophenone, benzoyl benzoate, 3,3′-dimethyl-4-methoxybenzophenone, polyvinyl benzophenone and α-hydroxycyclohexyl phenylketone. Examples of the ketal-based photopolymerization initiator include benzyl dimethyl ketal. Examples of the thioxanthone-based photopolymerization initiator include thioxanthone, 2-chlorothioxanthone, 2-methyl thioxanthone, 2,4-dimethyl thioxanthone, isopropyl thioxanthone, 2,4-diisopropyl thioxanthone and dodecyl thioxanthone.

The amount of the photopolymerization initiator used is not particularly limited, and, for example, is preferably 0.005 parts by weight to 1 part by weight based on 100 parts by weight of monomer components forming an acrylic polymer. The photopolymerization initiators may be used either alone or in combination of two or more thereof.

As the thermal polymerization initiator, examples thereof include azo-based polymerization initiators (such as 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,T-azobis(2-amidinopropan)dihydrochloride, 2,2′-azobis[2-(5-methyl-2-imidazolin-2-yl)propane]dihydrochloride, 2,2′-azobis(2-methylpropionamidine)disulfate and 2,2′-azobis(N,N′-dimethyleneisobutylamidine)dihydrochloride), peroxide-based polymerization initiators (such as dibenzoyl peroxide and tert-butyl permaleate) and redox-based polymerization initiators. The amount of the thermal polymerization initiator used is not particularly limited, and a known range that can be used as a thermal polymerization initiator may be used.

In the pressure-sensitive adhesive layer of the optical pressure-sensitive adhesive sheet according to the present invention, a crosslinking agent may be used. When the crosslinking agent is used, the acrylic polymer is crosslinked and thus cohesion force of the pressure-sensitive adhesive layer can be further increased. The crosslinking agent is not particularly limited, and well-known materials of the related art can be widely used. In particular, isocyanate-based crosslinking agents or epoxy-based crosslinking agents are preferably used. The crosslinking agents may be used alone or in combination of two or more thereof.

As the isocyanate-based crosslinking agents, examples thereof include lower aliphatic polyisocyanates such as 1,2-ethylene diisocyanate, 1,4-butylene diisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylene diisocyanate. In addition, examples thereof include an adduct of trimethylolpropane/tolylene diisocyanate (trade name of “CORONATE L”, manufactured by Nippon Polyurethane Industry Co., Ltd.); and an adduct of trimethylolpropane/hexamethylene diisocyanate (trade name of “CORONATE HL”, manufactured by Nippon Polyurethane Industry Co., Ltd.).

Examples of the epoxy-based crosslinking agents include epoxy-based resins having two or more epoxy groups in molecules thereof, in addition to N,N,N′,N′-tetraglycidyl-m-xylenediamine, diglycidylaniline, 1,3-bis(N,N-diglycidylaminomethyl)cyclohexane, 1,6-hexandioldiglycidylether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylol propane polyglycidyl ether, adipic acid diglycidyl ester, o-phthalic acid diglycidyl ester, triglycidyl-tris(2-hydroxyethyl)isocyanurate, resorsin diglycidyl ether and bisphenol-S-diglycidylether. As commercially available products thereof, examples thereof include trade name of “TETRAD C”, manufactured by Mitsubishi Gas Chemical Company Inc.

The amount of the crosslinking agent used is not particularly limited, and, for example, is preferably 0.001 parts by weight to 20 parts by weight, and more preferably 0.01 parts by weight to 10 parts by weight based on 100 parts by weight of the acrylic polymer. Among these, when the isocyanate-based crosslinking agent are used, the amount of the isocyanate-based crosslinking agent used is preferably 0.01 parts by weight to 20 parts by weight and more preferably 0.01 parts by weight to 3 parts by weight based on 100 parts by weight of the acrylic polymer. When the epoxy-based crosslinking agent are used, the amount of the epoxy-based crosslinking agent used is preferably 0.001 parts by weight to 5 parts by weight and more preferably 0.01 parts by weight to 5 parts by weight based on 100 parts by weight of the acrylic polymer.

In the pressure-sensitive adhesive layer of the optical pressure-sensitive adhesive sheet according to the present invention, well-known additives may be used as necessary within the amount ranges in which characteristics of the present invention are not impaired. Examples of the additives include crosslinking accelerators, tackifiers (for example, rosin derivative resin, polyterpene resin, petroleum resin, and oil soluble phenolic resin), anti-aging agents, fillers, coloring agents (for example, pigments and dyes), ultraviolet absorbers, antioxidants, chain transfer agents, plasticizers, softeners, surfactants, and antistatic agents.

As a method for forming the pressure-sensitive adhesive layer of the optical pressure-sensitive adhesive sheet according to the present invention, known/general methods for forming the pressure-sensitive adhesive layer can be used. In addition, the methods for forming the pressure-sensitive adhesive layer vary depending on polymerization methods of a base polymer and are not particularly limited, and examples thereof may include the following methods. (1) A pressure-sensitive adhesive layer is formed by coating on a substrate or release liner a composition (a pressure-sensitive adhesive composition or active-energy-ray curable pressure-sensitive adhesive composition) containing a mixture of monomer components (monomer mixture) forming a base polymer (for example, an acrylic polymer) or a partially polymerized product thereof, and additives such as a photopolymerization initiator added as necessary, and irradiating active energy rays thereon. (2) A pressure-sensitive adhesive layer is formed by coating on a substrate or release liner a composition (a pressure-sensitive adhesive composition or solvent type pressure-sensitive adhesive composition) (solution) containing a base polymer, a solvent and additives added as necessary, and drying and/or curing the composition. Heating and drying steps may be performed in the methods (1) and (2) if necessary. The “monomer mixture” means a mixture consisting of monomer components forming a base polymer. In addition, the “partially polymerized product thereof” means a composition in which one or more of the components in the monomer mixture are partially polymerized. The “pressure-sensitive adhesive composition” includes a meaning of a “composition for forming the pressure-sensitive adhesive layer”.

In the methods for forming the pressure-sensitive adhesive layer, coating of the pressure-sensitive adhesive composition may be performed by using any known coating methods. For example, well-known coaters such as a gravure roll coater, a reverse roll coater, a kiss roll coater, a dip roll coater, a bar coater, a knife coater, a spray coater, a comma coater, a direct coater, and the like can be used.

The thickness of the pressure-sensitive adhesive layer is not particularly limited, and is preferably 5 μm to 500 μm and more preferably 10 μm to 250 μm.

(Substrate)

In the case where the optical pressure-sensitive adhesive sheet according to the present invention is a pressure-sensitive adhesive sheet with substrate, the substrate is not particularly limited, and examples of the substrate include various kinds of optical films such as a plastic film, an anti-reflective (AR) film, a polarizer and a retardation film. Examples of materials of the plastic film include plastics materials such as polyester-based resins such as polyethylene terephthalate (PET), acrylic resins such as polymethylmethacrylate (PMMA), polycarbanate, triacetylcelluous, polysulfone, polyarylate and cyclic olefin based polymers such as cyclic olefin based polymer with trade name of “ARTON” manufactured by JSR Corporation and cyclic olefin based polymer with trade name of “ZEONOR” manufactured by ZEON Corporation. The plastic materials may be used either alone or in combination of two or more thereof. The “substrate” is a portion laminated to an adherend together with the pressure-sensitive adhesive layer, when the optical pressure-sensitive adhesive sheet is used (laminated) to the adherend (optical member). The release liner (separator) which is released in the use (lamination) of the optical pressure-sensitive adhesive sheet is not included in the “substrate”.

As the substrate, among them, a transparent substrate is preferable from the standpoint of achieving high transparency in the pressure-sensitive adhesive sheet. The “transparent substrate” is preferably a substrate having a total light transmittance of 85% or more in a visible light wavelength range (in accordance with JIS K 7361), and more preferably a substrate having a total light transmittance of 90% or more. Examples of the transparent substrate include a PET film, and non-oriented films such as trade names of “ARTON” and “ZEONOR”.

A thickness of the substrate is not particularly limited, but is preferably 12 μm to 50 μm. The substrate may be formed in any forms of a single layer or plural layers. Proper known/general surface treatment such as physical treatment such as corona discharge treatment and plasma treatment, and chemical treatment such as base coating treatment may be performed on the surface of the substrate.

The substrate may be an optical member. That is, the optical pressure-sensitive adhesive sheet according to the present invention may be constituted by a substrate composed of an optical member and a pressure-sensitive adhesive layer.

(Release Liner)

The pressure-sensitive adhesive layer surfaces (pressure-sensitive adhesive surface) of the optical pressure-sensitive adhesive sheet of the present invention may be protected by a release liner (separator) until they are used. The respective pressure-sensitive adhesive surfaces of the optical pressure-sensitive adhesive sheet may be protected by two release liners, respectively, or may be protected in a roll-shape wound form by a release liner of which both sides are formed as release faces. The release liner is used as protecting material of the pressure-sensitive adhesive layer, and is released when it is laminated to an adherend. In the case where the optical pressure-sensitive adhesive sheet according to the present invention is a substrateless double-sided pressure-sensitive adhesive sheet, the release liner also acts as a support of the pressure-sensitive adhesive layer. The release liner may be optionally provided. As the release liner, a general release paper may be used, and example thereof include, without limitation thereto, a substrate with a release-treated layer, a low adhesion substrate made of a fluorine-based polymer and a low adhesion substrate made of a non-polar polymer. Examples of the substrate with the release-treated layer include plastic films or papers of which surfaces are treated by release treating agents such as a silicone-based release treating agent, a long chain alkyl-based release treating agent, fluorine-based release treating agent, and molybdenum sulfate. Examples of the fluorine-based polymer of a low adhesion substrate made of a fluorine-based polymer include polytetrafluoroethylene, polychlorotrifluoroethylene, polyvinyl fluoride, polyvinylidene fluoride, tetrafluoroethylene-hexafluoropropylene copolymer and chlorofluoroethylene-vinylidene fluoride copolymer. Examples of the non-polar polymer of a low adhesion substrate made of a non-polar polymer include olefin-based resins (such as polyethylene and polypropylene). The release liner may be foamed by know/general methods. The thickness of the release liner are not particularly limited.

(Optical Pressure-Sensitive Adhesive Sheet)

The optical pressure-sensitive adhesive sheet according to the present invention functions as an insulating layer and includes a pressure-sensitive adhesive layer in which changes in capacitance caused by changes in frequency of a signal or changes in environments (temperature and humidity) are suppressed. In addition, such a pressure-sensitive adhesive layer has excellent thickness accuracy. Furthermore, the optical pressure-sensitive adhesive sheet according to the present invention has excellent transparency.

More specifically, the optical pressure-sensitive adhesive sheet according to the present invention is used for laminating optical members or for manufacturing optical products.

The optical members refer to members having optical properties such as a polarized property, a photorefractivity property, a light scattering property, a light reflective property, a light transmitting property, a light absorbing property, a light diffractive property, an optical rotation property and visibility. Although the optical members are not particularly limited as far as they are members having optical properties, examples thereof include members constituting devices (optical devices) such as display devices (image display devices) and input devices, or members used in the devices. Examples of the optical members include a polarizing plate, a wave plate, a retardation film, an optical compensation film, a brightness enhancing film, a light guide plate, a reflective film, an anti-reflective film, a transparent conductive film (e.g. ITO film and the like), a design film, a decoration film, a surface protection film, a prism, lens, a color filter, a transparent substrate, and members in which these are laminated. The “plate” and “film” include plate form, film form and sheet form, and examples of the “polarizing plate” include “a polarizing film” and “a polarizing sheet”.

Examples of the display devices include a liquid crystal display device, an organic electroluminescence (EL) display device, a plasma display panel (PDP) and an electronic paper. Examples of the input devices include touch panels, particularly, such as an electric capacity type touch panel.

The optical pressure-sensitive adhesive sheet according to the present invention is preferably used for the purpose of laminating members constituting the electric capacity type touch panel.

The optical members are not particularly limited, and examples thereof include members (e.g., a sheet, film or plate type of members) composed of an acrylic resin, polycarbonate, polyethylene terephthalate, glass and metal thin films. The “optical members” in the present invention may include members (a design film, a decorating film and a surface protection film) paying a role of decoration or protection while maintaining visibility of a display device or input device that is an adherent as described above.

Although embodiments of laminating optical members by the optical pressure-sensitive adhesive sheet according to the present invention are not particularly limited, they may include (1) an embodiment of interposing the optical pressure-sensitive adhesive sheet of the present invention between the optical members to laminate the optical members to each other, (2) an embodiment of laminating an optical member to any members other than the optical member through the optical pressure-sensitive adhesive sheet of the present invention, and (3) an embodiment of laminating the optical pressure-sensitive adhesive sheet of the present invention including the optical member to optical members or any members other than the optical members. In the above embodiment (3), it is preferable that the optical pressure-sensitive adhesive sheet of the present invention is an optical pressure-sensitive adhesive sheet in which an optical member (e.g. an optical film such as a polarizing film) is used as a substrate.

A pressure-sensitive adhesive optical member having the pressure-sensitive adhesive layer (preferably, the pressure-sensitive adhesive layer according to the present invention) on at least one surface of the optical member may be obtained by adhering and laminating the optical pressure-sensitive adhesive sheet according to the present invention on the surface (at least one surface) of the optical member.

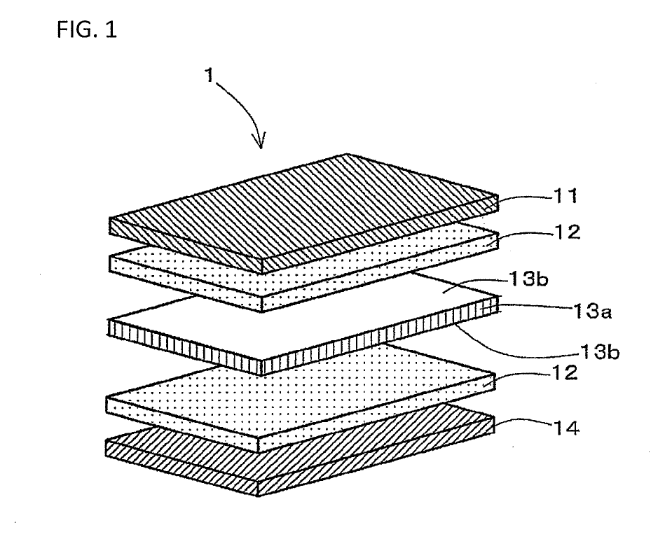

As a more specific example thereof, FIG. 1 shows a schematic view illustrating an embodiment of an electric capacity type touch panel formed by laminating members using an optical pressure-sensitive adhesive sheet according to the present invention. In FIG. 1, reference numeral 1 represents an electric capacity type touch panel, reference numeral 11 represents a transparent protective lens, reference numeral 12 represents an optical pressure-sensitive adhesive sheet, reference numeral 13a represents an ITO glass substrate, reference numeral 13b represents an ITO film (transparent conductive film), and reference numeral 14 represents a liquid crystal display. In the electric capacity type touch panel 1, the “transparent protective lens 11” and the “ITO glass substrate 13a, on both sides of which the ITO films 13b are provided” are laminated through the optical pressure-sensitive adhesive sheet 12, and the “ITO glass substrate 13a, on both sides of which the ITO films 13b are provided” and the “liquid crystal display 14” are laminated through the optical pressure-sensitive adhesive sheet 12. In the electric capacity type touch panel 1, one in which the ITO film 13b is provided on both surfaces of the ITO glass substrate 13a is used, but in general, in the electric capacity type touch panel, one in which the ITO film is provided on one surface of the ITO glass substrate may be used.

Such an electric capacity type touch panel includes a pressure-sensitive adhesive layer as the insulating layer in the optical pressure-sensitive adhesive sheet. In the pressure-sensitive adhesive layer, since changes in capacitance caused by changes in frequency of a signal or changes in environments (temperature and humidity) are small and stable, sensitivity and operational stability are excellent. In addition, the optical pressure-sensitive adhesive sheet has high transparency, visibility is excellent.

(Optical Device)

According to the present invention, the optical pressure-sensitive adhesive sheet is used in optical devices. In the optical devices, the optical pressure-sensitive adhesive sheet is used, for example, when laminating members constituting optical devices or members used in the devices. Since the optical pressure-sensitive adhesive sheet is used in such an optical device, sensitivity, operational stability, and furthermore visibility are excellent.

Examples of the optical device include a display device (image display device) such as a liquid crystal display device, an organic EL (electroluminescence) display device, a PDP (plasma display panel) and an electronic paper, and an input device such as a touch panel (particularly, electric capacity type touch panel).

### EXAMPLES

Hereinafter, the present invention will be described in more detail with reference to the following Examples, but the present invention is not limited to the following Examples.

### Example 1

(Preparation of Photopolymerizable Composition)

40 parts by weight of 2-ethylhexyl acrylate, 59 parts by weight of 2-methoxyethyl acrylate, 1 part by weight of 4-hydroxybutyl acrylate, 0.05 parts by weight of 2,2-dimethoxy-1,2-diphenyl-1-one (trade name “IRGACURE 651”, manufactured by Chiba Japan K.K.), and 0.05 parts by weight of 1-hydroxy-cyclohexyl-phenyl-ketone (trade name “IRGACURE 184”, manufactured by Chiba Japan K.K.) were placed into a four-neck flask, and the mixture was partially photopolymerized by exposing to UV under the nitrogen atmosphere to obtain a partially polymerized product (monomer syrup) having the polymerization ratio of 10%.

0.1 parts by weight (in solid matter equivalent) of isocyanate compound (trade name “CORONATE L”, manufactured by NIPPON POLYURETHANE INDUSTRY CO., LTD., solid concentration: 75 wt %) was added to 100 parts by weight of the partially polymerized product, and then, they were uniformly mixed to prepare a photopolymerizable composition.

(Preparation of Pressure-Sensitive Adhesive Sheet)

The above photopolymerizable composition was coated on a release-treated surface of 75 μm-thick polyester film, one surface of which had been release-treated with silicone, such that the thickness thereof was 150 μm, thereby forming a coating layer. A release-treated surface of 38 μm-thick polyester film, one surface of which had been release-treated with silicone, was laminated on the coating layer. Then, the 38 μm-thick polyester film was irradiated with UV using black light obtained by adjusting the height of a lamp such that the intensity of light on an irradiation surface beneath the lamp was 5 mW/cm². Polymerization was performed until the light intensity of 3600 mJ/cm² was irradiated thereon, thereby preparing an acrylic pressure-sensitive adhesive sheet having a thickness of 150 μm.

### Example 2

(Preparation of Photopolymerizable Composition)

69 parts by weight of 2-ethylhexyl acrylate, 30 parts by weight of 2-methoxyethyl acrylate, 1 part by weight of 4-hydroxybutyl acrylate, 3 parts by weight of acrylic acid, 0.05 parts by weight of 2,2-dimethoxy-1,2-diphenyl-1-one (trade name “IRGACURE 651”, manufactured by Chiba Japan K.K.), and 0.05 parts by weight of 1-hydroxy-cyclohexyl-phenyl-ketone (trade name “IRGACURE 184”, manufactured by Chiba Japan K.K.) were placed into a four-neck flask, and the mixture was partially photopolymerized by exposing to UV under the nitrogen atmosphere to obtain a partially polymerized product (monomer syrup) having the polymerization ratio of 10%.

0.01 parts by weight of trimethylolpropane triacrylate was added to 100 parts by weight of the partially polymerized product and then, they were uniformly mixed to prepare a photopolymerizable composition.

(Preparation of Pressure-Sensitive Adhesive Sheet)

The above photopolymerizable composition was coated on a release-treated surface of 75 μm-thick polyester film, one surface of which had been release-treated with silicone, such that the thickness thereof was 150 μm, thereby forming a coating layer. A release-treated surface of 38 μm-thick polyester film, one surface of which had been release-treated with silicone, was laminated on the coating layer. Then, the 38 μm-thick polyester film was irradiated with UV using black light obtained by adjusting the height of a lamp such that the intensity of light on an irradiation surface beneath the lamp was 5 mW/cm². Polymerization was performed until the light intensity of 3600 mJ/cm² was irradiated thereon, thereby preparing an acrylic pressure-sensitive adhesive sheet having a thickness of 150 μm.

### Example 3

(Preparation of Photopolymerizable Composition)

68 parts by weight of 2-ethylhexyl acrylate, 24 parts by weight of 2-methoxyethyl acrylate, 6 parts by weight of N-vinyl-pyrrolidone, 2 parts by weight of hydroxyethyl acrylamide, 0.05 parts by weight of 2,2-dimethoxy-1,2-diphenyl-1-one (trade name “IRGACURE 651”, manufactured by Chiba Japan K.K.), and 0.05 parts by weight of 1-hydroxy-cyclohexyl-phenyl-ketone (trade name “IRGACURE 184”, manufactured by Chiba Japan K.K.) were placed into a four-neck flask, and the mixture was partially photopolymerized by exposing to UV under the nitrogen atmosphere to obtain a partially polymerized product (monomer syrup) having the polymerization ratio of 10%.

0.015 parts by weight of trimethylolpropane triacrylate was added to 100 parts by weight of the partially polymerized product and then, they were uniformly mixed to prepare a photopolymerizable composition.

(Preparation of Pressure-Sensitive Adhesive Sheet)

The above photopolymerizable composition was coated on a release-treated surface of 75 μm-thick polyester film, one surface of which had been release-treated with silicone, such that the thickness thereof was 150 μm, thereby forming a coating layer. A release-treated surface of 38 μm-thick polyester film, one surface of which had been release-treated with silicone, was laminated on the coating layer. Then, the 38 μm-thick polyester film was irradiated with UV using black light obtained by adjusting the height of a lamp such that the intensity of light on an irradiation surface beneath the lamp was 5 mW/cm². Polymerization was performed until the light intensity of 3600 mJ/cm² was irradiated thereon, thereby preparing an acrylic pressure-sensitive adhesive sheet having a thickness of 150

### Example 4

(Preparation of Photopolymerizable Composition)

70 parts by weight of 2-ethylhexyl acrylate, 26 parts by weight of N-vinyl-pyrrolidone, 4 parts by weight of hydroxyethyl acrylamide, 0.05 parts by weight of 2,2-dimethoxy-1,2-diphenyl-1-one (trade name “IRGACURE 651”, manufactured by Chiba Japan K.K.), and 0.05 parts by weight of 1-hydroxy-cyclohexyl-phenyl-ketone (trade name “IRGACURE 184”, manufactured by Chiba Japan K.K.) were placed into a four-neck flask, and the mixture was partially photopolymerized by exposing to UV under the nitrogen atmosphere to obtain a partially polymerized product (monomer syrup) having the polymerization ratio of 10%.

0.015 parts by weight of trimethylolpropane triacrylate was added to 100 parts by weight of the partially polymerized product and then, they were uniformly mixed to prepare a photopolymerizable composition.

(Preparation of Pressure-Sensitive Adhesive Sheet)

The above photopolymerizable composition was coated on a release-treated surface of 75 μm-thick polyester film, one surface of which had been release-treated with silicone, such that the thickness thereof was 180 μm, thereby forming a coating layer. A release-treated surface of 38 μm-thick polyester film, one surface of which had been release-treated with silicone, was laminated on the coating layer. Then, the 38 μm-thick polyester film was irradiated with UV using black light obtained by adjusting the height of a lamp such that the intensity of light on an irradiation surface beneath the lamp was 5 mW/cm². Polymerization was performed until the light intensity of 3600 mJ/cm² was irradiated thereon, thereby preparing an acrylic pressure-sensitive adhesive sheet having a thickness of 180 μm.

### Example 5

28 parts by weight of 2-ethylhexyl acrylate, 64 parts by weight of ethyl acrylate, 5 parts by weight of methyl methacrylate, 0.4 parts by weight of azobisisobutyronitrile, and 100 parts by weight of ethyl acetate were placed into a four-neck flask and they were caused to react with each other at about 60° C. under the nitrogen atmosphere to obtain an acrylic polymer solution. 1 part by weight (in solid matter equivalent) of isocyanate compound (trade name “CORONATE L”, manufactured by NIPPON POLYURETHANE INDUSTRY CO., LTD., solid concentration: 75 wt %) was added to the acrylic polymer solution. This acrylic polymer solution was coated on a release-treated surface of 50 μm-thick polyester film, one surface of which had been release-treated with silicone, followed by heating and drying. The 38 μm-thick polyester film, one surface of which had been release-treated with silicone, was laminated thereon (on the coating layer), thereby preparing an acrylic pressure-sensitive adhesive sheet having a thickness of 30 μm.

(Evaluation)

The relative dielectric constant, dielectric tangent, thickness accuracy, transmittance, and the like were measured with respect to the pressure-sensitive adhesive sheet in the Examples. The measurement results were shown in Table 1.

(Relative Dielectric Constant and Dielectric Tangent)

A relative dielectric constant at a frequency of 1.0×10⁶ Hz, a relative dielectric constant at a frequency of 1.0×10⁴ Hz, a dielectric tangent at a frequency of 1.0×10⁶ Hz, and a dielectric tangent at a frequency of 1.0×10⁴ Hz were measured under the following condition in accordance with JIS K 6911.

Measurement method: Volumetric method (device: Agilent Technologies 4294A Precision Impedance Analyzer was used)

Electrode constitution: Aluminum plate having a diameter of 12.1 mm and the thickness of 0.5 mm

Counter electrode: 3 oz copper plate

Measurement environment: 23±1° C., 52±1% RH

In Table 1, [A] represents a relative dielectric constant at a frequency of 1.0×10⁶ Hz, [B] represents a relative dielectric constant at a frequency of 1.0×10⁴ Hz, [C] represents a dielectric tangent at a frequency of 1.0×10⁶ Hz, and [D] represents a dielectric tangent at a frequency of 1.0×10⁴ Hz.

In addition, based on measured values of the relative dielectric constant at a frequency of 1.0×10⁶ Hz and the relative dielectric constant at a frequency of 1.0×10⁴ Hz, when the relative dielectric constant at a frequency of 1.0×10⁴ Hz is 100%, the percentage (%) of the relative dielectric constant at a frequency of 1.0×10⁶ Hz was determined with the following expression.

(Relative dielectric constant at frequency of 1.0×10⁶ Hz)/(Relative dielectric constant at frequency of 1.0×10⁴ Hz)×100

The percentage (%) of the relative dielectric constant at a frequency of 1.0×10⁶ Hz when the relative dielectric constant at a frequency of 1.0×10⁴ Hz is 100% is shown in the item “[A]/[B]” of Table 1.

Furthermore, based on measured values of the dielectric tangent at a frequency of 1.0×10⁶ Hz and the dielectric tangent at a frequency of 1.0×10⁴ Hz, the absolute value of a difference between the dielectric tangent at a frequency of 1.0×10⁶ Hz and the dielectric tangent at a frequency of 1.0×10⁴ Hz was obtained.

The absolute value of the difference between the dielectric tangent at a frequency of 1.0×10⁶ Hz and the dielectric tangent at a frequency of 1.0×10⁴ Hz is shown in the item “[C]-[D]” of Table 1.

(Thickness Accuracy)

The thickness accuracy was determined as follows. Five points are set in a range of 50 mm×75 mm in a longitudinal direction and the thickness of each measurement point is measured using a 1/1000 dial gauge. A numerical value obtained by dividing the difference between the maximum thickness and a desired thickness by the desired thickness is represented by percent (refer to the following expression (1)), and a numerical value obtained by dividing the difference between the minimum thickness and the desired thickness by the desired thickness is represented by percent (refer to the following expression (2)). The former absolute value is compared to the latter absolute value and a larger numerical value is set as the thickness accuracy (%).

(Maximum thickness−desired thickness)/(Desired thickness)×100 (1)

(Minimum thickness−desired thickness)/(Desired thickness)×100 (2)

(Total Light Transmittance in Visible Light Wavelength and Haze)

The total light transmittance and haze can be measured using, for example, a haze meter (trade name “HM-150”, manufactured by Murakami Color Research Laboratory Co., Ltd.).

TABLE 1

| | Relative dielectric | | | Dielectric | | | | Total light transmittance | |
|---|---|---|---|---|---|---|---|---|---|
| | constant | | | tangent | | | Thickness | in visible light | |
| | [A] | [B] | [A]/[B] | [C] | [D] | [C] − [D] | accuracy (%) | wavelength (%) | Haze |
| Example 1 | 5.96 | 6.56 | 91 | 0.086 | 0.005 | 0.081 | 5 | 92 | 0.6 |
| Example 2 | 4.65 | 5.36 | 87 | 0.101 | 0.011 | 0.090 | 5 | 92 | 0.6 |
| Example 3 | 4.30 | 5.87 | 73 | 0.116 | 0.082 | 0.034 | 5 | 92 | 0.6 |
| Example 4 | 3.16 | 4.00 | 79 | 0.065 | 0.117 | 0.052 | 5 | 92 | 0.6 |
| Example 5 | 4.17 | 5.34 | 78 | 0.102 | 0.040 | 0.062 | 4 | 92 | 0.5 |

When an electric capacity type touch panel illustrated in FIG. 1 was manufactured using the pressure-sensitive adhesive sheets prepared in Examples, sensitivity and stability were excellent and malfunction was not caused in the electric capacity type touch panel using the pressure-sensitive adhesive sheets prepared in Examples.

The optical pressure-sensitive adhesive sheet according to the present invention is used for laminating optical members or for manufacturing optical products. Particularly, the optical pressure-sensitive adhesive sheet according to the present invention is preferably used for laminating members constituting an electric capacity type touch panel and the like.

While the invention has been described in detail and with reference to specific embodiments thereof, it will be apparent to one skilled in the art that various changes and modifications can be made therein without departing from the spirit and scope thereof.

This application is based on Japanese Patent Application No. 2011-278535 filed on Dec. 20, 2011, the entire subject matter of which is incorporated herein by reference.

The present invention provides the following optical pressure-sensitive adhesive sheet, liquid crystal display device and input device.

(1) An optical pressure-sensitive adhesive sheet comprising a pressure-sensitive adhesive layer, wherein a relative dielectric constant at a frequency of 1 MHz is 2 to 8, and a dielectric tangent at a frequency of 1 MHz is more than 0 and 0.2 or less.

(2) The optical pressure-sensitive adhesive sheet according to (1), wherein the relative dielectric constant at a frequency of 1.0×10⁶ Hz is 60% or more of a relative dielectric constant at a frequency of 1.0×10⁴ Hz.

(3) The optical pressure-sensitive adhesive sheet according to (1) or (2), wherein an absolute value of a difference between the dielectric tangent at a frequency of 1.0×10⁶ Hz and a dielectric tangent at a frequency of 1.0×10⁴ Hz is 0.15 or less.

(4) The optical pressure-sensitive adhesive sheet according to any one of (1) to (3), which has a thickness accuracy of 10% or less.

(5) The optical pressure-sensitive adhesive sheet according to any one of (1) to (4), wherein the pressure-sensitive adhesive layer is an acrylic pressure-sensitive adhesive layer.

(6) The optical pressure-sensitive adhesive sheet according to (5), wherein the acrylic pressure-sensitive adhesive layer comprises, as a base polymer, an acrylic polymer formed from a component comprising, as an essential monomer component, alkyl (meth)acrylate having a straight-chain or branched alkyl group having 1 to 14 carbon atoms and/or alkoxyalkyl (meth)acrylate.

(7) The optical pressure-sensitive adhesive sheet according to (5) or (6), wherein the acrylic pressure-sensitive adhesive layer is formed by an ultraviolet-ray polymerization method through ultraviolet irradiation to a pressure-sensitive adhesive composition.

(8) The optical pressure-sensitive adhesive sheet according to any one of (1) to (7), which is used for laminating members contained in a touch panel.

(9) The optical pressure-sensitive adhesive sheet according to (8), wherein the touch panel is an electric capacity type touch panel.

(10) A liquid crystal display device comprising the optical pressure-sensitive adhesive sheet according to any one of (1) to (9).

(11) An input device comprising the optical pressure-sensitive adhesive sheet according to any one of (1) to (9).

### DESCRIPTION OF REFERENCE NUMERALS AND SIGNS

1 Electric capacity type touch panel
11 Transparent protective lens
12 Optical pressure-sensitive adhesive sheet
13a ITO glass substrate
13b ITO film
14 Liquid crystal display

What is claimed is:

1. An optical pressure-sensitive adhesive sheet comprising a pressure-sensitive adhesive layer, wherein a relative dielectric constant at a frequency of 1 MHz is 2 to 8, and a dielectric tangent at a frequency of 1 MHz is more than 0 and 0.2 or less.

2. The optical pressure-sensitive adhesive sheet according to claim 1, wherein the relative dielectric constant at a frequency of 1.0×10⁶ Hz is 60% or more of a relative dielectric constant at a frequency of 1.0×10⁴ Hz.

3. The optical pressure-sensitive adhesive sheet according to claim 1, wherein an absolute value of a difference between the dielectric tangent at a frequency of 1.0×10⁶ Hz and a dielectric tangent at a frequency of 1.0×10⁴ Hz is 0.15 or less.

4. The optical pressure-sensitive adhesive sheet according to claim 1, which has a thickness accuracy of 10% or less.

5. The optical pressure-sensitive adhesive sheet according to claim 1, wherein the pressure-sensitive adhesive layer is an acrylic pressure-sensitive adhesive layer.

6. The optical pressure-sensitive adhesive sheet according to claim 5, wherein the acrylic pressure-sensitive adhesive layer comprises, as a base polymer, an acrylic polymer formed from a component comprising, as an essential monomer component, alkyl (meth)acrylate having a straight-chain or branched alkyl group having 1 to 14 carbon atoms and/or alkoxyalkyl (meth)acrylate.

7. The optical pressure-sensitive adhesive sheet according to claim 5, wherein the acrylic pressure-sensitive adhesive layer is formed by an ultraviolet-ray polymerization method through ultraviolet irradiation to a pressure-sensitive adhesive composition.

8. The optical pressure-sensitive adhesive sheet according to claim 1, which is used for laminating members contained in a touch panel.

9. The optical pressure-sensitive adhesive sheet according to claim 8, wherein the touch panel is an electric capacity type touch panel.

10. A liquid crystal display device comprising the optical pressure-sensitive adhesive sheet according to claim 1.

11. An input device comprising the optical pressure-sensitive adhesive sheet according to claim 1.

12. The optical pressure-sensitive adhesive sheet according to claim 2, wherein an absolute value of a difference between the dielectric tangent at a frequency of 1.0×10⁶ Hz and a dielectric tangent at a frequency of 1.0×10⁴ Hz is 0.15 or less.

13. The optical pressure-sensitive adhesive sheet according to claim 2, which has a thickness accuracy of 10% or less.

14. The optical pressure-sensitive adhesive sheet according to claim 3, which has a thickness accuracy of 10% or less.

15. The optical pressure-sensitive adhesive sheet according to claim 12, which has a thickness accuracy of 10% or less.

16. The optical pressure-sensitive adhesive sheet according to claim 2, wherein the pressure-sensitive adhesive layer is an acrylic pressure-sensitive adhesive layer.

17. The optical pressure-sensitive adhesive sheet according to claim 3, wherein the pressure-sensitive adhesive layer is an acrylic pressure-sensitive adhesive layer.

18. The optical pressure-sensitive adhesive sheet according to claim 12, wherein the pressure-sensitive adhesive layer is an acrylic pressure-sensitive adhesive layer.

19. The optical pressure-sensitive adhesive sheet according to claim 4, wherein the pressure-sensitive adhesive layer is an acrylic pressure-sensitive adhesive layer.

20. The optical pressure-sensitive adhesive sheet according to claim 13, wherein the pressure-sensitive adhesive layer is an acrylic pressure-sensitive adhesive layer.
